(19) United States
(12) Patent Application Publication
(10) Pub. No.: US 2013/0076792 A1
(43) Pub. Date: Mar. 28, 2013

(54) IMAGE PROCESSING DEVICE, IMAGE PROCESSING METHOD, AND COMPUTER READABLE MEDIUM

(71) Applicants: Shinsuke TAKUMA, Tokyo (JP); Takehisa SOURAKU, Shizuoka (JP)

(72) Inventors: Shinsuke TAKUMA, Tokyo (JP); Takehisa SOURAKU, Shizuoka (JP)

(73) Assignee: SONY CORPORATION, Tokyo (JP)

(21) Appl. No.: 13/585,918

(22) Filed: Aug. 15, 2012

(30) Foreign Application Priority Data
Sep. 26, 2011 (JP) 2011-209084

(51) Int. Cl. G09G 5/00; G09G 5/34; G06K 9/32

(52) U.S. Cl. 345/634; 382/293; 382/298; 345/619; 345/655; 345/681; 345/666

(57) ABSTRACT

An apparatus includes an object adjustment unit and a synthesis unit. The object adjustment unit is configured to modify an image of an object based on parameters of an image of a face to create a modified image of the object. The synthesis unit is configured to synthesize the image of the face with the modified image of the object.

### CROSS-REFERENCE TO RELATED APPLICATIONS

The present application is based upon and claims the benefit of priority under 35 U.S.C. §119 of Japanese Priority Patent Application JP 2011-209084 filed in the Japanese Patent Office on Sep. 26, 2011, the entire contents of which are hereby incorporated by reference.

### BACKGROUND

The present disclosure relates to an image processing device, an image processing method, and a program encoded on a non-transitory computer readable medium.

In recent years, a technique for synthesizing various objects onto an image obtained by image capturing (hereinafter also referred to as “captured image”) becomes widely used. Although, various objects can be synthesized onto a captured image, for example, when an image of a subject (for example, a human being, an animal, and the like) is captured, images of things to be put on the subject (for example, clothing, a bag, and the like) can be synthesized onto the captured image. Various techniques are disclosed for synthesizing objects onto a captured image.

For example, a technique for synthesizing a clothing image according to an image capturing condition (for example, image capturing location and image capturing time) onto a person image is disclosed (see, for example, Japanese Unexamined Patent Application Publication No. 2005-136841). According to the technique, a clothing image according to an image capturing condition is synthesized onto a person image, so that it is possible to synthesize a clothing image suitable to an image capturing condition onto a person image.

### SUMMARY

However, for example, Japanese Unexamined Patent Application Publication No. 2005-136841 does not disclose a technique for synthesizing a clothing image at an appropriate position in a captured image. Therefore, it is desired that a technique for synthesizing an object at an appropriate position in a captured image is proposed.

Therefore, the present disclosure herein proposes a new and improved image processing device, image processing method, and program encoded on a non-transitory computer readable medium which can synthesize an object onto an appropriate position in a captured image.

According to an embodiment of the present disclosure, there is provided an image processing device including an image synthesis unit that synthesizes an object, in which origin coordinates are set, onto a captured image so that the origin coordinates correspond to synthesis reference coordinates based on a position of a face area included in the captured image.

Also, according to the embodiment of the present disclosure, there is provided an image processing method including synthesizing an object, in which origin coordinates are set, onto a captured image so that the origin coordinates correspond to synthesis reference coordinates based on a position of a face area included in the captured image.

Also, according to the embodiment of the present disclosure, there is provided a program encoded on a non-transitory computer readable medium for causing a computer to function as an image processing device including an image synthesis unit that synthesizes an object, in which origin coordinates are set, onto a captured image so that the origin coordinates correspond to synthesis reference coordinates based on a position of a face area included in the captured image.

In a further embodiment, an apparatus includes an object adjustment unit and a synthesis unit. The object adjustment unit is configured to modify an image of an object based on parameters of an image of a face to create a modified image of the object. The synthesis unit is configured to synthesize the image of the face with the modified image of the object.

### BRIEF DESCRIPTION OF THE DRAWINGS

FIG. 1 is a diagram showing a configuration example of an image processing system according to an embodiment of the present disclosure.

FIG. 2 is a diagram showing a hardware configuration example of an image processing device.

FIG. 3 is a diagram showing a functional configuration example of a control unit.

FIG. 4 is a diagram for explaining an outline of image synthesis.

FIG. 5 is a diagram for explaining a determination example of synthesis reference coordinates by a reference position determination unit.

FIG. 6 is a diagram for explaining a screen transition example controlled by an operation control unit.

FIG. 7 is a diagram for explaining an object adjustment example (movement).

FIG. 8 is a diagram for explaining an object adjustment example (scaling).

FIG. 9 is a diagram for explaining an object adjustment example (rotation).

FIG. 10 is a diagram for explaining an object synthesis example onto a captured image including a plurality of face areas.

FIG. 11 is a sequence diagram showing an operation example of the image processing system.

FIG. 12 is a flowchart showing an operation example of the image processing device.

### DETAILED DESCRIPTION OF EMBODIMENT

Hereinafter, an embodiment of the present disclosure will be described with reference to the drawings. In the description and the drawings, the same reference numerals are given to constituent elements having substantially the same function and configuration, and redundant description will be omitted.

In the description and the drawings, a plurality of constituent elements having substantially the same function and configuration may be differentiated by attaching an alphabetical suffix to the same reference numeral. However, if it is not necessary to differentiate a plurality of constituent elements having substantially the same function and configuration, only the same reference numeral is given.

The “DETAILED DESCRIPTION OF EMBODIMENT” will be described according to the order of items below.

1. Description of embodiment
1-1. Configuration example of image processing system
1-2. Hardware configuration example of image processing device
1-3. Functional configuration of image processing device
1-4. Operation example of image processing system
1-5. Operation example of image processing device

2. Conclusion

### 1. DESCRIPTION OF EMBODIMENT

First, an embodiment of the present disclosure will be sequentially described in detail.

### 1-1. Configuration Example of Image Processing System

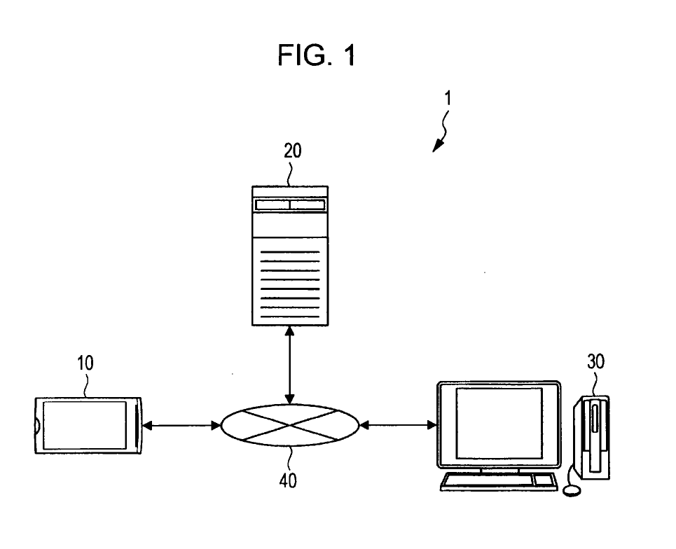

First, a configuration example of an image processing system according to the embodiment of the present disclosure will be described. FIG. 1 is a diagram showing the configuration example of the image processing system according to the embodiment of the present disclosure.

As shown in FIG. 1, the image processing system 1 according to the embodiment of the present disclosure includes an image processing device 10, a server 20, and a generation device 30 as an example. Each of the image processing device 10, the server 20, and the generation device 30 is connected to a network 40 and can communicate with each other via the network 40. However, the configuration shown in FIG. 1 is only an example, so that the server 20, the generation device 30, and the network 40 are provided if necessary. That is, the function described hereafter as performed by the server 20 and the generation device 30 could also be performed by the image processing device 10.

The image processing device 10 synthesizes an object onto a captured image. Although the captured image and the object are not particularly limited, for example, when an image of a subject (for example, a human being, an animal, and the like) is captured, the image processing device 10 synthesizes an image of things to be put on the subject (for example, clothing, a bag, and the like) onto the captured image. The image processing device 10 may be any type of device such as, for example, a digital still camera, a smart phone, a PC (Personal Computer), a tablet-type computer, and an image scanner. The image processing device 10 may be an image synthesis module mounted on the devices mentioned above.

The server 20 stores an object received from the generation device 30. When the server 20 receives a request for acquiring an object (hereinafter also simply referred to as “acquisition request”) from the image processing device 10 via the network 40, the server 20 returns the object to the image processing device 10 via the network 40. For example, the image processing device 10 includes object identification information for identifying an object to be acquired in the acquisition request, so that the image processing device 10 can acquire a desired object from the server 20. However, if the image processing device 10 does not acquire an object from the server 20, there may be no server 20.

The generation device 30 generates an object according to an operation by an object creator and transmits the generated object to the server 20 via the network 40. When the object creator registers an object created by the object creator, an object for sales promotion, or the like in the server 20 via the generation device 30, the object is downloaded to the image processing device 10 by a user of the image processing device 10 and the object is synthesized onto a captured image by the image processing device 10. If the user of the image processing device 10 likes the object, sales of clothing or the like shown by the object may be promoted. However, if it is not necessary to generate an object, there may be no generation device 30.

The configuration example of the image processing system 1 according to the embodiment of the present disclosure has been described. Subsequently, a hardware configuration example of the image processing device 10 according to the embodiment of the present disclosure will be described.

### 1-2. Hardware Configuration Example of Image Processing Device

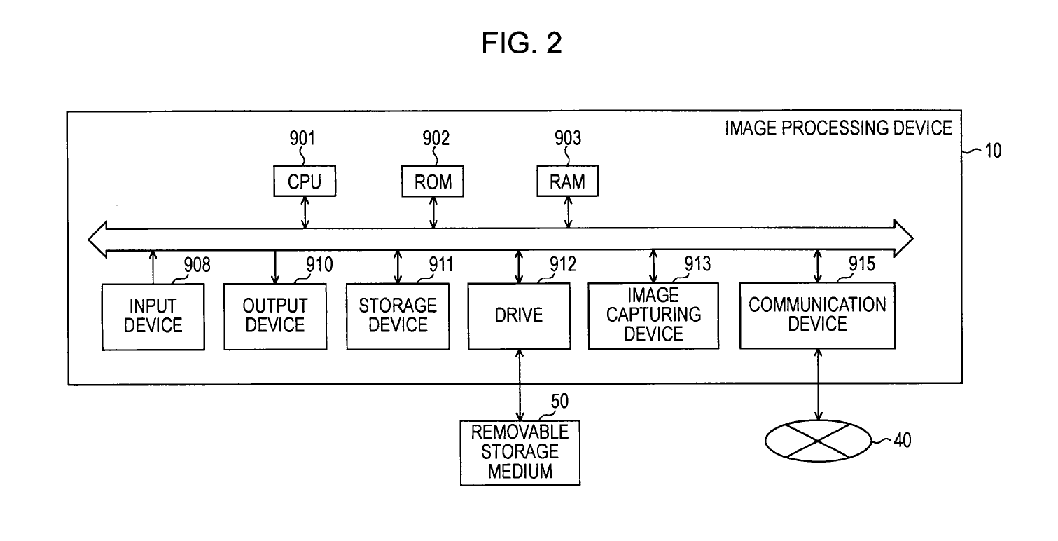

Subsequently, the hardware configuration example of the image processing device 10 according to the embodiment of the present disclosure will be described. FIG. 2 is a diagram showing the hardware configuration example of the image processing device 10 according to the embodiment of the present disclosure.

As shown in FIG. 2, the image processing device 10 according to the embodiment of the present disclosure includes, as an example, a CPU (Central Processing Unit) 901, a ROM (Read Only Memory) 902, a RAM (Random Access Memory) 903, an input device 908, an output device 910, a storage device 911, a drive 912, an image capturing device 913, and a communication device 915. However, the hardware configuration shown in FIG. 2 is only an example, so that the hardware configuration of the image processing device 10 may be changed if necessary.

The CPU 901 functions as an arithmetic processing device and a control device and can function as a control unit that controls all operations in the image processing device 10 according to various programs. The CPU 901 may be a microprocessor. The ROM 902 stores programs and arithmetic parameters used by the CPU 901. The RAM 903 temporarily stores a program executed by the CPU 901 and parameters changing correspondingly when the CPU 901 executes the program. These devices mentioned above are connected to each other by a host bus including a CPU bus and the like.

The input device 908 has an input section, from which a user inputs information, including a mouse, a keyboard, a touch panel, a button, a microphone, a switch, and a lever, and an input control circuit which generates an input signal based on an input from a user and outputs the input signal to the CPU 901. The user of the image processing device 10 can input various data into the image processing device 10 and instruct the image processing device 10 to perform a processing operation by operating the input device 908.

The output device 910 includes a display device such as, for example, a liquid crystal display (LCD) device, an OLED (Organic Light Emitting Diode) device, and a lamp. The output device 910 further includes an audio output device such as a speaker and headphones. For example, the display device displays a captured image and a generated image. On the other hand, the audio output device converts audio data into sound or voice and outputs the sound or voice.

The storage device 911 is a data storage device configured as an example of a storage unit of the image processing device 10 according to the embodiment. The storage device 911 may include a storage medium, a recording device for recording data on the storage medium, a reading device for reading data from the storage medium, a deleting device for deleting data recorded on the storage medium, and the like. The storage device 911 stores programs executed by the CPU 901 and various data.

The drive 912 is a reader/writer for a storage medium and is installed in the image processing device 10 or externally connected to the image processing device 10. The drive 912 reads information stored in a mounted removable storage medium 50 such as a magnetic disk, an optical disk, a magneto-optical disk, or a semiconductor memory, and outputs the information to the RAM 903. The drive 912 can write information to the removable storage medium 50.

The image capturing device 913 includes an image capturing optical system such as an image capturing lens for collecting light and a zoom lens and a signal conversion element such as a CCD (Charge Coupled Device) or a CMOS (Complementary Metal Oxide Semiconductor). The image capturing optical system collects light reflected from a subject and forms a subject image on a signal conversion unit. The signal conversion element converts the formed subject image into an electrical image signal.

The communication device 915 is, for example, a communication interface including a communication device for connecting to a network. The communication device 915 may be a communication device that operates over a wireless LAN (Local Area Network), a communication device that operates over LTE (Long Term Evolution), or a wired communication device that communicates via wire. For example, the communication device 915 can communicate with the server 20 and the generation device 30 via the network 40.

The network 40 is a wired transmission path or a wireless transmission path of information transmitted from devices connected to the network 40. For example, the network 40 may include public networks such as the Internet, a telephone network, and a satellite communication network, various LANs (Local Area Networks) including Ethernet (registered trademark), and WANs (Wide Area Networks). Also, the network 40 may include a dedicated line network such as IP-VPN (Internet Protocol-Virtual Private Network).

The hardware configuration example of the image processing device 10 according to the embodiment of the present disclosure has been described. Subsequently, the functional configuration of the image processing device 10 according to the embodiment of the present disclosure will be described.

### 1-3. Functional Configuration of Image Processing Device

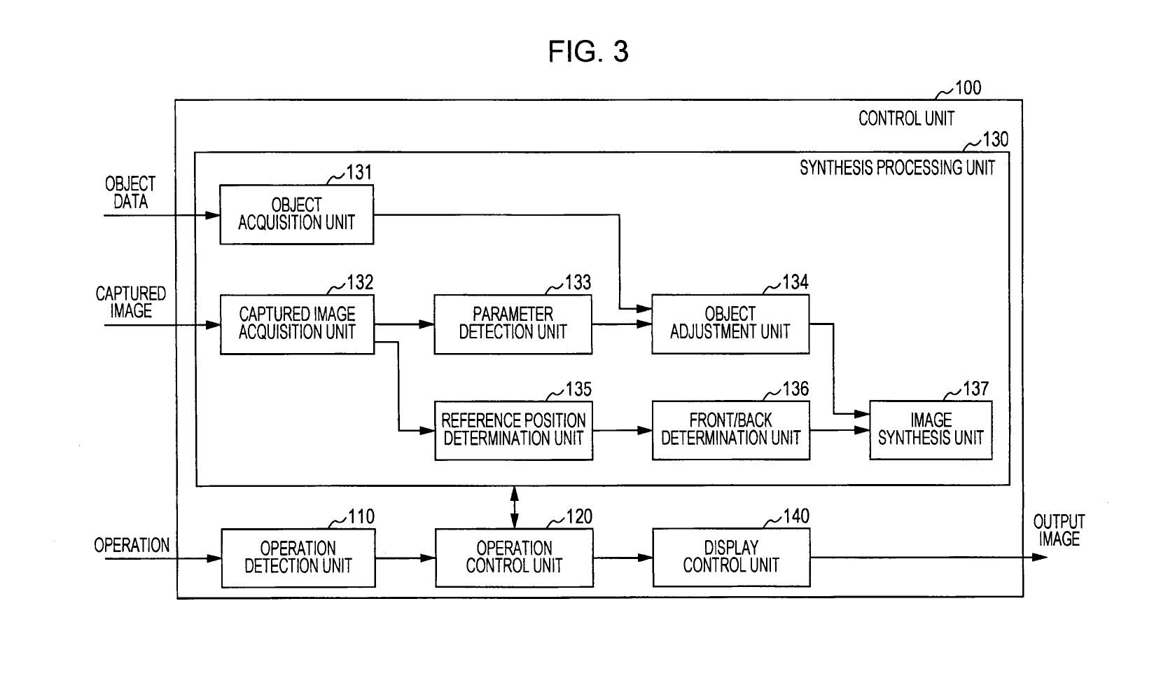

Subsequently, the functional configuration of the image processing device 10 according to the embodiment of the present disclosure will be described. FIG. 3 is a diagram showing a functional configuration example of the control unit included in the image processing device 10 according to the embodiment of the present disclosure.

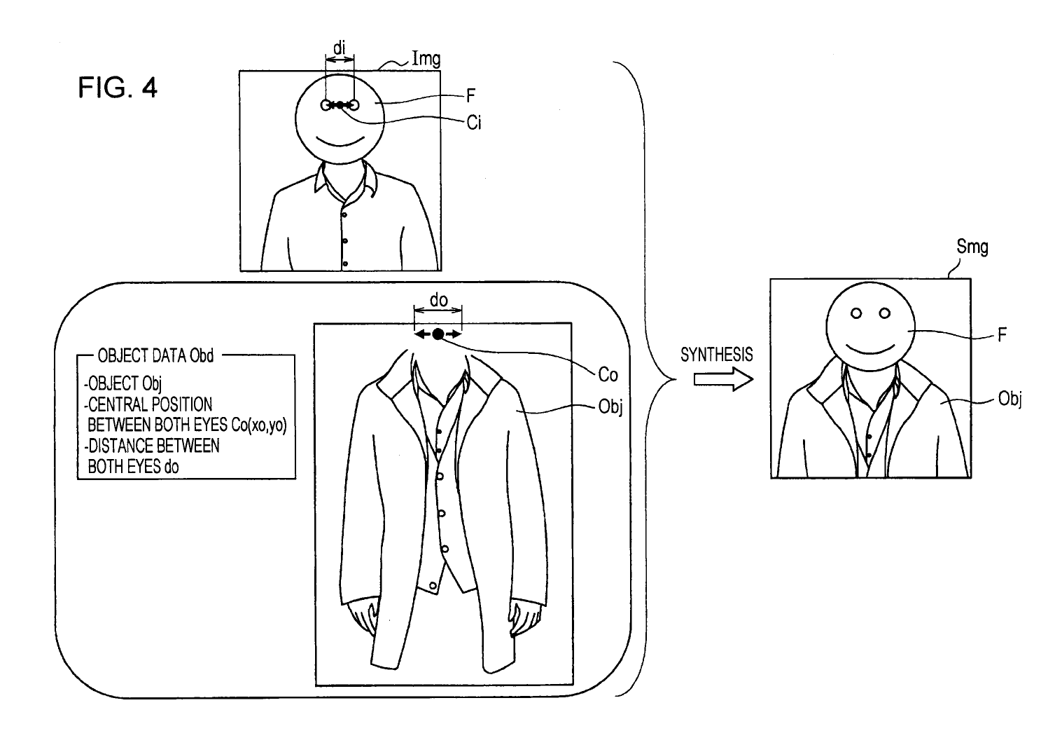

As shown in FIG. 3, the control unit 100 according to the embodiment of the present disclosure includes an operation detection unit 110, an operation control unit 120, a synthesis processing unit 130, and a display control unit 140. The synthesis processing unit 130 includes an object acquisition unit 131, a captured image acquisition unit 132, a parameter detection unit 133, an object adjustment unit 134, a reference position determination unit 135, a front/back determination unit 136, and an image synthesis unit 137. First, an outline of image synthesis will be described with reference to FIG. 4.

FIG. 4 is a diagram for explaining an outline of image synthesis. As shown in FIG. 4, in an object Obj, a central position between both eyes Co (xo, yo) is set as an example of the origin coordinates. The origin coordinates may be manually set by an object creator or may be automatically set by the generation device 30. Both eyes mean, for example, the right eye and the left eye of a subject (for example, a human being or an animal) which can wear the object Obj. The central position between both eyes means, for example, a midpoint of a line segment connecting both eyes located when the subject wares the object Obj.

As an example of the origin coordinates, as shown in FIG. 4, the central position between both eyes Co is used. However, the origin coordinates are not limited to the central position between both eyes Co, but can be appropriately changed according to selection of the synthesis reference coordinates described later.

A distance between both eyes do is set in the object Obj. The distance between both eyes do may be manually set by the object creator or may be automatically set by the generation device 30. The distance between both eyes means, for example, a length of a line segment connecting both eyes located when the subject wares the object Obj.

The image format of the object Obj is not limited, and for example, may be a PNG format. When the image format is the PNG format, transparency (α channels) can be set for each of a plurality of pixels included in the image, so that if the object Obj is synthesized onto a captured image according to transparency which is set to change gradually, synthesis of the object Obj is expected to be more natural. Hereinafter, a set of the object Obj, the central position between both eyes Co, and the distance between both eyes do is referred to as object data Obd.

The object acquisition unit 131 has a function to acquire an object. The object acquisition unit 131 can output an acquired object to the object adjustment unit 134. The object acquisition unit 131 can also output an acquired object to the image synthesis unit 137. An object may be acquired from the storage device 911, may be acquired from the removable storage medium 50, or may be acquired from other devices (for example, server 20) via the communication device 915.

The captured image acquisition unit 132 has a function to acquire a captured image. The captured image acquisition unit 132 can output an acquired captured image to the parameter detection unit 133. The captured image acquisition unit 132 can also output an acquired captured image to the reference position determination unit 135, the front/back determination unit 136, and the image synthesis unit 137. The captured image may be an image captured by the image capturing device 913, may be acquired from the storage device 911, may be acquired from the removable storage medium 50, or may be acquired from other devices (for example, server 20) via the communication device 915.

The reference position determination unit 135 determines the synthesis reference coordinates based on a position of a face area included in the captured image. For example, the reference position determination unit 135 can determine the synthesis reference coordinates based on a position of a face area F included in a captured image Img by analyzing the captured image Img. More specifically, the reference position determination unit 135 extracts an amount of features from the captured image Img and compares the amount of features with a database in which amounts of features are stored in advance, so that the reference position determination unit 135 determines the synthesis reference coordinates based on the position of the face area F included in the captured image Img.

A central position between both eyes Ci of the face area F included in the captured image Img is an example of the synthesis reference coordinates based on the position of the face area F included in the captured image Img. However, the synthesis reference coordinates based on the position of the face area F included in the captured image Img is not limited to the central position between both eyes Ci of the face area F included in the captured image Img. For example, the synthesis reference coordinates based on the position of the face area F included in the captured image Img may be a position of a predetermined portion (for example, nose or mouth) of the face area F included in the captured image Img.

When the reference position determination unit 135 uses an amount of features of both eyes as the amount of features, the reference position determination unit 135 can determine the synthesis reference coordinates on the basis of detection of the central position between both eyes Ci included in the face area F included in the captured image Img. For example, the reference position determination unit 135 can determine the central position between both eyes Ci included in the face area F included in the captured image Img as the synthesis reference coordinates.

Let us return to FIG. 3. The functions of the parameter detection unit 133 and the front/back determination unit 136 will be described later. The object adjustment unit 134 has a function to adjust the object Obj. The adjustment method of the object Obj by the object adjustment unit 134 is not particularly limited. For example, the object adjustment unit 134 may adjust the scale of the object according to the distance between both eyes di included in the face area F.

More specifically, the object adjustment unit 134 may adjust the scale of the object Obj so that the distance between both eyes do corresponds to the distance between both eyes di included in the face area F. Or, when an approximate range is determined in advance, the object adjustment unit 134 may adjust the scale of the object Obj so that the distance between both eyes do is within the approximate range based on the distance between both eyes di included in the face area F. Another method for adjusting the object Obj will be described later.

The image synthesis unit 137 synthesizes an object, in which the origin coordinates are set, onto a captured image so that the origin coordinates correspond to the synthesis reference coordinates based on the position of the face area included in the captured image. Although the synthesis reference coordinates may be determined by the reference position determination unit 135, the synthesis reference coordinates may be determined by a functional unit other than the reference position determination unit 135. For example, if synthesis reference coordinates determined by a device other than the image processing device 10 is added to the captured image, the image synthesis unit 137 may acquire the synthesis reference coordinates added to the captured image and use the synthesis reference coordinates.

When the object Obj is adjusted by the object adjustment unit 134, the image synthesis unit 137 synthesizes the object adjusted by the object adjustment unit 134 onto the captured image Img. A synthesized image Smg shown in FIG. 4 is an image in which the central position between both eyes Ci is the synthesis reference coordinates and which is obtained by, when the central position between both eyes Ci is the origin coordinates, synthesizing the object Obj onto the captured image Img by the image synthesis unit 137 so that the origin coordinates correspond to the synthesis reference coordinates. The synthesized image can be displayed by the output device 910 according to display control by the display control unit 140.

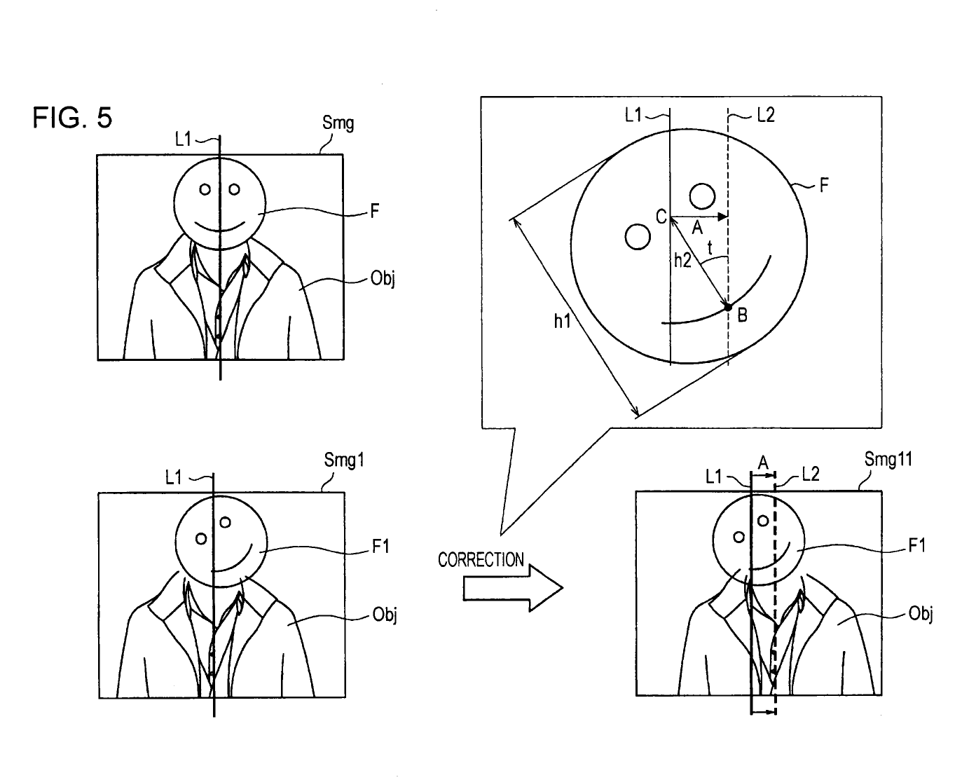

Although the outline of image synthesis has been described, various methods other than that described above can be employed as a determination method of the synthesis reference coordinates performed by the reference position determination unit 135. Next, a determination example of the synthesis reference coordinates performed by the reference position determination unit 135 will be described with reference to FIG. 5.

FIG. 5 is a diagram for explaining the determination example of the synthesis reference coordinates performed by the reference position determination unit 135. Here, the central position between both eyes of the face area F included in the captured image is determined as the synthesis reference coordinates and the object Obj is synthesized onto each of two captured images so that the origin coordinates correspond to the synthesis reference coordinates. In one of the two captured images, the face area F included in the captured image has no slope. In the other one of the two captured images, the face area F included in the captured image has a slope.

When the face area F included in the captured image has no slope, it is assumed that a vertical line L1 passing through the central position between both eyes of the face area F included in the captured image corresponds to a vertical line passing through the central position of the body area included in the captured image. Therefore, a synthesized image Smg, in which the object Obj is synthesized on a natural position of the captured image by the image synthesis unit 137, is obtained.

On the other hand, when the face area F included in the captured image has a slope, it is assumed that a vertical line L1 passing through the central position between both eyes of the face area F included in the captured image does not correspond to a vertical line passing through the central position of the body area included in the captured image. Therefore, a synthesized image Smg1, in which the object Obj is synthesized on an unnatural position of the captured image by the image synthesis unit 137, is obtained.

Therefore, when the face area F included in the captured image has a slope, the reference position determination unit 135 may determine the synthesis reference coordinates by correcting the central position between both eyes of the face area F included in the captured image using the degree of the slope (t). More specifically, the reference position determination unit 135 calculates a distance h2 obtained by multiplying the vertical size h1 of the face area F included in the captured image by a predetermined rate (for example, 40%), assumes that the distance h2 is a distance from the central position C between both eyes to the rotation center B, and calculates an amount of correction A by the formula (1) below.

A=h2×sin(t) (1)

The amount of correction A is calculated as a vector quantity in the horizontal direction. For example, the reference position determination unit 135 can appropriately correct the object Obj by moving the object Obj based on the amount of correction A. Therefore, a synthesized image Smg11, in which the object Obj is synthesized on a natural position of the captured image by the image synthesis unit 137, is obtained. In the synthesized image Smg11, a vertical line L2 passing through the central position of the object Obj, which has been corrected, substantially corresponds to a vertical line passing through the central position of the body area included in the captured image.

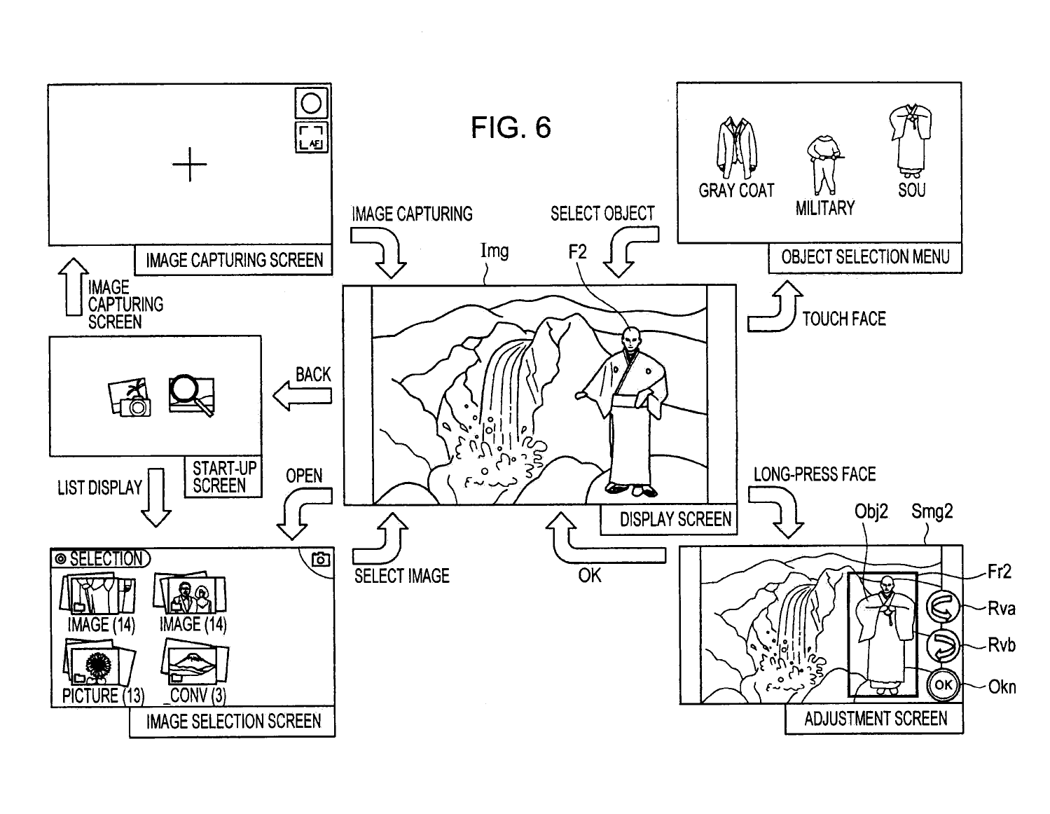

The determination example of the synthesis reference coordinates performed by the reference position determination unit 135 has been described. Subsequently, a screen transition example controlled by the operation control unit 120 will be described with reference to FIG. 6. The screen transition example described below is only an example of screen transition. An operation detected by the operation detection unit 110 is provided, for example, from a user to the input device 908. A screen whose display is controlled by the display control unit 140 is displayed by, for example, the output device 910.

FIG. 6 is a diagram for explaining the screen transition example controlled by the operation control unit 120. As shown in FIG. 6, for example, when the image processing device 10 is started, a start-up screen is displayed and controlled by the display control unit 140. When the start-up screen is displayed and controlled, if the operation detection unit 110 detects an operation for selecting an image capturing mode, an image capturing screen is displayed and controlled by the display control unit 140.

On the other hand, when the start-up screen is displayed and controlled, if the operation detection unit 110 detects an operation for selecting a list display mode, an image selection screen is displayed and controlled by the display control unit 140. Displayable images are displayed on the image selection screen. The displayable images may be acquired from the storage device 911, may be acquired from the removable storage medium 50, or may be acquired from other devices (for example, server 20) via the communication device 915.

When the image capturing screen is displayed and controlled by the display control unit 140, if the operation detection unit 110 detects an image capturing operation, a display screen is displayed and controlled by the display control unit 140. On the display screen, a captured image Img2 captured and obtained by the image capturing device 913 is displayed and a face area F2 is included in the captured image Img2.

When the display screen is displayed and controlled by the display control unit 140, if the operation detection unit 110 detects a back operation, the start-up screen is displayed and controlled by the display control unit 140. When the display screen is displayed and controlled by the display control unit 140, if the operation detection unit 110 detects an open operation, the image selection screen is displayed and controlled by the display control unit 140.

When the image selection screen is displayed and controlled by the display control unit 140, if the operation detection unit 110 detects an operation for selecting an image, the display screen is displayed and controlled by the display control unit 140. The selected image can be displayed on the display screen.

When the display screen is displayed and controlled by the display control unit 140, if the operation detection unit 110 detects an operation for selecting the face area F2, an object selection menu is displayed and controlled by the display control unit 140. As shown in FIG. 6, the operation for selecting the face area F2 may be, for example, a touch operation to the face area F2 on a touch panel performed by the user. On the object selection menu, objects acquired by the object acquisition unit 131 are displayed. In FIG. 6, “Gray coat”, “military”, and “Sou” are displayed as an example of the objects.

When the object selection menu is displayed and controlled by the display control unit 140, if the operation detection unit 110 detects an operation for selecting an object, the selected object is acquired by the object acquisition unit 131 and a synthesized image in which the acquired object is synthesized onto the captured image Img2 is displayed and controlled by the display control unit 140. The synthesis of the selected object and the captured image Img2 can be performed by the image synthesis unit 137.

Although, in the example shown in FIG. 6, the object acquisition unit 131 acquires an object on the basis of an operation detected by the operation detection unit 110, the acquisition method of the object is not limited to this example. For example, the object acquisition unit 131 may analyze an attribute of the face area included in the captured image acquired by the captured image acquisition unit 132 and may acquire an object according to the analysis result.

Examples of the attribute of the face area include gender, age, and facial expression (for example, smiling face, sad face, and the like). For example, if there is information that associates attributes of the face areas with objects, the object acquisition unit 131 can acquire an object associated with an attribute of the face area by referring to the information. For example, if attributes of the face areas are added to objects, the object acquisition unit 131 can acquire an object to which an attribute of the face area is added as an analysis result.

When the display screen is displayed and controlled by the display control unit 140, if the operation detection unit 110 detects an operation for selecting the face area F2 onto which the object is synthesized, an adjustment screen is displayed and controlled by the display control unit 140. As shown in FIG. 6, the operation for selecting the face area F2 onto which the object is synthesized may be, for example, a long-press operation to the face area F2 on the touch panel performed by the user. On the adjustment screen, a synthesized image Smg2, in which the selected object Obj2 is synthesized onto the captured image Img2, is displayed.

In FIG. 6, a frame Fr2 enclosing the selected object Obj2 is displayed. When the user sees the frame Fr2, the user can easily know the size, shape, position of the object Obj2. In FIG. 6, a rotation button Rva, a rotation button Rvb, and an OK button Okn are also displayed. When the adjustment screen is displayed and controlled by the display control unit 140, if the operation detection unit 110 detects an operation for selecting OK (for example, an operation to press the OK button Okn), the display screen is displayed and controlled by the display control unit 140. The synthesized image Smg2, which was displayed on the adjustment screen, can be displayed on the display screen.

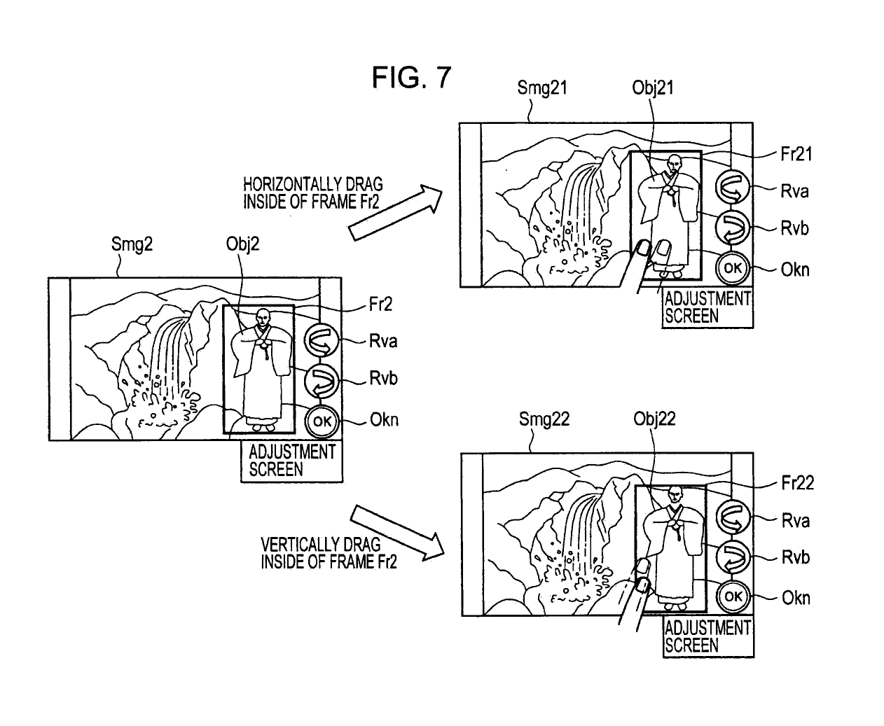

The screen transition example controlled by the operation control unit 120 has been described. When the adjustment screen is displayed and controlled by the display control unit 140, the object Obj2 can be adjusted. Subsequently, object adjustment examples performed by the object adjustment unit 134 will be described with reference to FIGS. 7 to 9.

FIG. 7 is a diagram for explaining an object adjustment example (movement). As shown in FIG. 7, for example, when the adjustment screen is displayed and controlled by the display control unit 140, if the operation detection unit 110 detects an operation for moving the object Obj2, the position of the object Obj2 is adjusted by the display control unit 140 on the basis of the detected operation.

As shown in FIG. 7, the operation for moving the object Obj2 may be, for example, a drag operation to inside the frame Fr2, which the user performs on the touch panel. In a synthesized image Smg21, there is an object Obj21 obtained by moving the object Obj2 according to the drag operation to inside the frame Fr2 in the horizontal direction (for example, in the leftward direction). In the synthesized image Smg21, there is also a frame Fr21 obtained by moving the frame Fr2 along with the object Obj2.

In a synthesized image Smg22, there is an object Obj22 obtained by moving the object Obj2 according to the drag operation to inside the frame Fr2 in the vertical direction (for example, in the downward direction). In the synthesized image Smg22, there is also a frame Fr22 obtained by moving the frame Fr2 along with the object Obj2. When the operation for moving the object Obje2 is performed by a drag operation, the display control unit 140 may control the moving operation of the object Obj2 only in the vertical direction or the horizontal direction on the basis of the angle of the drag. When the angle of the drag from the horizontal is smaller than a predetermined angle (for example, 20 degrees), the display control unit 140 may move the object Obj2 in the horizontal direction, and when the angle of the drag from the vertical is smaller than a predetermined angle (for example, 20 degrees), the display control unit 140 may move the object Obj2 in the vertical direction. When the angle of the drag from the horizontal is greater than or equal to a predetermined angle (for example, 20 degrees) and the angle of the drag from the vertical is greater than or equal to a predetermined angle (for example, 20 degrees), the display control unit 140 does not control the moving operation of the object Obj2 only in the vertical direction or the horizontal direction, but may move the object Obj2 in the direction of the drag.

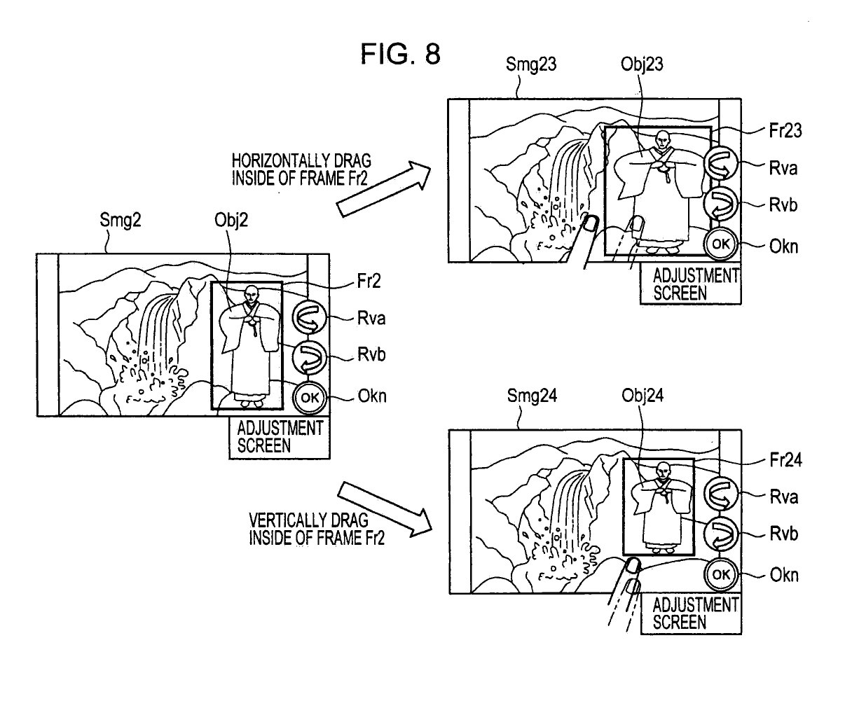

FIG. 8 is a diagram for explaining an object adjustment example (scaling). As shown in FIG. 8, for example, when the adjustment screen is displayed and controlled by the display control unit 140, if the operation detection unit 110 detects an operation for adjusting the scale of the object Obj2, the scale of the object Obj2 is adjusted by the display control unit 140 on the basis of the detected operation. At this time, for example, the display control unit 140 can adjust the scale of the object Obj2 with reference to the position of the origin coordinates set in the object Obj2 without changing the position of the origin coordinates.

As shown in FIG. 8, the operation for adjusting the scale of the object Obj2 may be, for example, a drag operation to outside the frame Fr2, which the user performs on the touch panel. In a synthesized image Smg23, there is an object Obj23 obtained by adjusting the scale of the object Obj2 according to the drag operation to outside the frame Fr2 (for example, left of the frame Fr2) in the horizontal direction (for example, in the leftward direction). In particular, the object Obj23 is an object obtained by adjusting the scale of the object Obj2 with reference to the position of the origin coordinates set in the object Obj2 without changing the position of the origin coordinates. In the synthesized image Smg23, there is also a frame Fr23 obtained by adjusting the scale of the frame Fr2 while adjusting the scale of the object Obj2. When the touch panel is a multi-touch type panel, an operation for enlarging the object Obj2 may be a pinch-out operation.

In a synthesized image Smg24, there is an object Obj24 obtained by adjusting the scale of the object Obj2 according to the drag operation to outside the frame Fr2 (for example, left of the frame Fr2) in the vertical direction (for example, in the upward direction). In particular, the object Obj24 is an object obtained by adjusting the scale of the object Obj2 with reference to the position of the origin coordinates set in the object Obj2 without changing the position of the origin coordinates. In the synthesized image Smg24, there is also a frame Fr24 obtained by adjusting the scale of the frame Fr2 while adjusting the scale of the object Obj2. When the touch panel is a multi-touch type panel, an operation for reducing the object Obj2 may be a pinch-in operation. When the operation for adjusting the scale of the object Obje2 is performed by a drag operation, the display control unit 140 may control the scale adjustment operation of the object Obj2 only in the vertical direction or the horizontal direction on the basis of the angle of the drag. When the angle of the drag from the horizontal is smaller than a predetermined angle (for example, 20 degrees), the display control unit 140 may adjust the scale of the object Obj2 in the horizontal direction, and when the angle of the drag from the vertical is smaller than a predetermined angle (for example, 20 degrees), the display control unit 140 may adjust the scale of the object Obj2 in the vertical direction. When the angle of the drag from the horizontal is greater than or equal to a predetermined angle (for example, 20 degrees) and the angle of the drag from the vertical is greater than or equal to a predetermined angle (for example, 20 degrees), the display control unit 140 does not control the scale adjustment operation of the object Obj2 only in the vertical direction or the horizontal direction, but may adjust the scale of the object Obj2 in the direction of the drag.

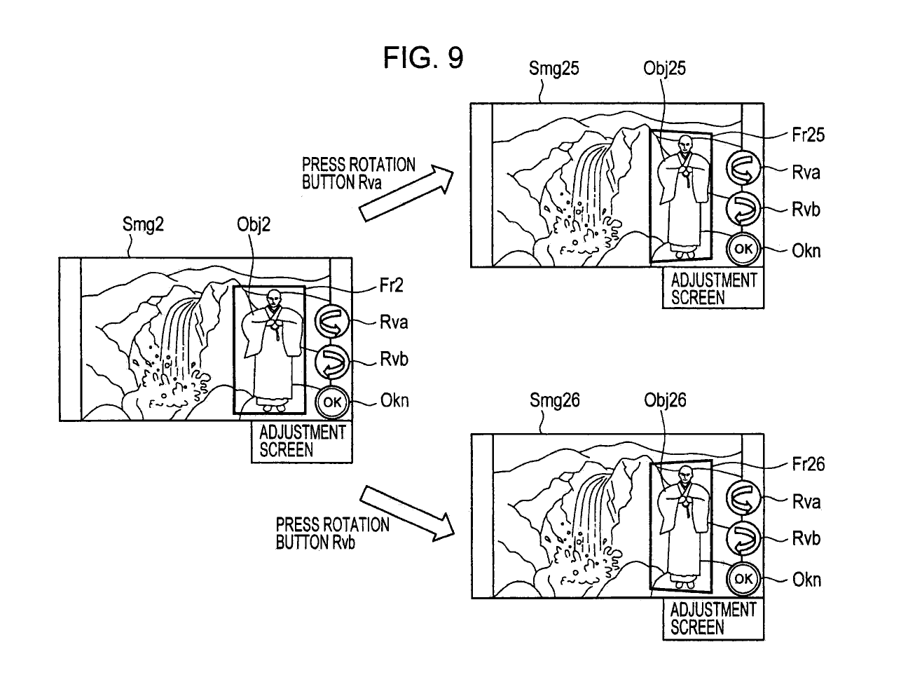

FIG. 9 is a diagram for explaining an object adjustment example (rotation). As shown in FIG. 9, for example, when the adjustment screen is displayed and controlled by the display control unit 140, if the operation detection unit 110 detects an operation for adjusting the angle of the object Obj2, the angle of the object Obj2 is adjusted by the display control unit 140 on the basis of the detected operation.

As shown in FIG. 9, the operation for adjusting the angle of the object Obj2 may be, for example, a pressing operation of the rotation button Rva or the rotation button Rvb by the user. In a synthesized image Smg25, there is an object Obj25 obtained by adjusting the angle of the object Obj2 according to the pressing operation of the rotation button Rva. In the synthesized image Smg25, there is also a frame Fr25 obtained by adjusting the angle of the frame Fr2 while adjusting the angle of the object Obj2.

In a synthesized image Smg26, there is an object Obj26 obtained by adjusting the angle of the object Obj2 according to the pressing operation of the rotation button Rvb. In the synthesized image Smg26, there is also a frame Fr26 obtained by adjusting the angle of the frame Fr2 while adjusting the angle of the object Obj2.

Although, in the example shown in FIG. 9, the object adjustment unit 134 adjusts the angle of the object on the basis of the operation detected by the operation detection unit 110, the object adjustment unit 134 may adjust the angle of the object according to the angle of the face area included in the captured image. For example, the object adjustment unit 134 may adjust the angle of the object so that the angle of the face area included in the captured image corresponds to the angle of the object. For example, the object adjustment unit 134 may detect the positions of both eyes included in the captured image and set the angle of a plane passing through the detected positions of both eyes as the angle of the face area. For example, the object adjustment unit 134 may set the angle of a vertical plane passing through the detected positions of both eyes as the angle of the face area.

The adjustment method of the object by the object adjustment unit 134 is not limited to the above examples. For example, if there is no uniformity of pixel values between a body area included in the captured image and a body area included in the object, an unnatural synthesized image may be generated. Therefore, the object adjustment unit 134 may adjust the pixel values of the body area included in the object according to the pixel values of the body area included in the captured image. For example, the object adjustment unit 134 may adjust the pixel values of the body area included in the object so that the pixel values of the body area included in the object correspond to the pixel values of the body area included in the captured image.

Although the body area included in the captured image is not particularly limited, the body area included in the captured image may be, for example, the face area. Although the body area included in the object is not particularly limited, the body area included in the object may be, for example, an area where the skin is exposed (for example, hand area, foot area, and the like). The pixel value may be an RGB value defined for each pixel. For example, the pixel values of the body area included in the captured image can be detected by the parameter detection unit 133 as an example of parameters detected from the captured image. If there is a uniformity of pixel values between the body area included in the captured image and the body area included in the object, a natural synthesized image can be generated.

For example, if there is no uniformity of brightness between a thing included in the captured image and the object, an unnatural synthesized image may be generated. Therefore, the object adjustment unit 134 may adjust the brightness of the object according to the brightness of the thing included in the captured image. For example, the object adjustment unit 134 may adjust the brightness of the object so that the brightness of the object corresponds to the brightness of the thing included in the captured image.

Although the thing included in the captured image is not particularly limited, the thing included in the captured image may be, for example, the face area or other things (for example, desk, shelf, and the like). For example, the brightness may be an average value of RGB values defined for pixels. For example, the brightness of the thing included in the captured image can be detected by the parameter detection unit 133 as an example of a parameter detected from the captured image. If there is a uniformity of brightness between the thing included in the captured image and the object, a natural synthesized image can be generated.

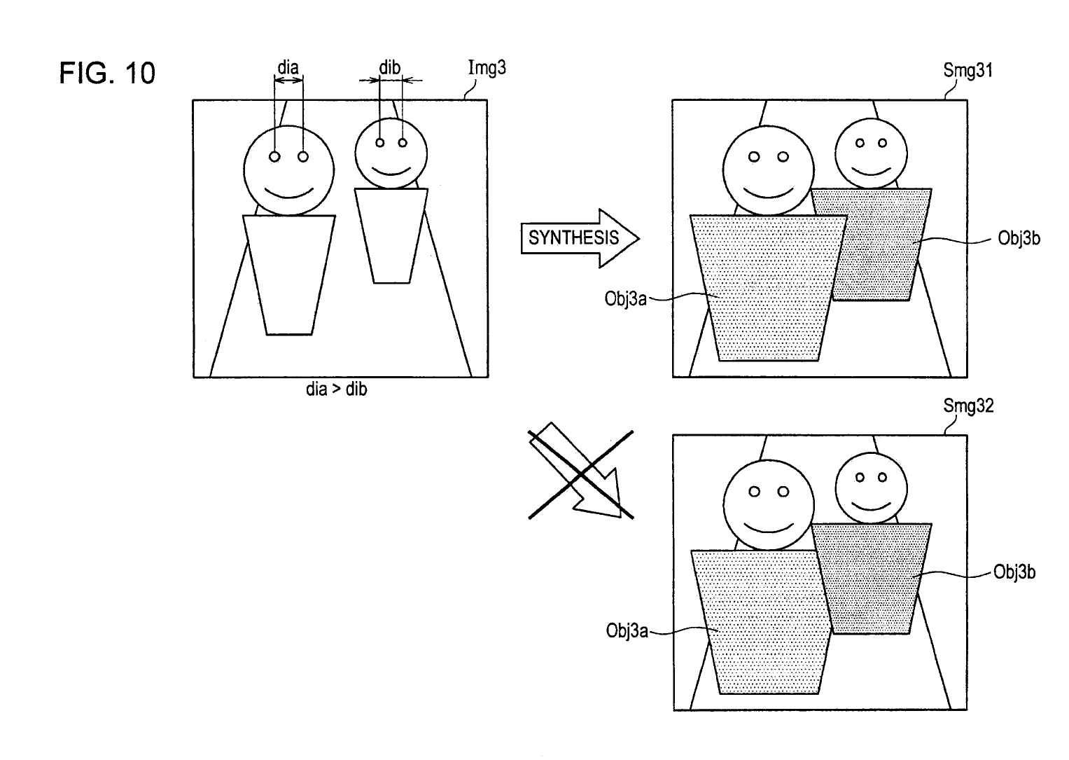

The adjustment examples of the object performed by the object adjustment unit 134 have been described. By the way, there may be a plurality of face areas in the captured image. In such a case, objects are synthesized at a plurality of positions on the captured image and there is a probability that an order of the synthesis of the objects is mistaken. A method for reducing the probability will be described below with reference to FIG. 10.

FIG. 10 is a diagram for explaining an object synthesis example onto a captured image including a plurality of face areas. As shown in FIG. 10, a captured image Img3 includes a plurality of face areas. In this case, for example, if an object Obj3a is synthesized first according to the position of a face area located in the foreground and thereafter an object Obj3b is synthesized according to the position of a face area located in the background, a synthesized image Smg32 in which the order of the synthesis is mistaken.

Therefore, when a plurality of face areas are included in the captured image, it is desired that the front/back determination unit 136 determine a front/back relationship between the plurality of face areas. In this case, it is desired that the image synthesis unit 137 synthesizes an object with respect to each of the plurality of face areas according to the front/back relationship determined by the front/back determination unit 136. The determination method of the front/back relationship of the plurality of face areas is not particularly limited. For example, the front/back determination unit 136 may determine that a face area in which the distance between both eyes is relatively long is located in the foreground and a face area in which the distance between both eyes is relatively short is located in the background. In this case, it is desired that the image synthesis unit 137 synthesizes objects in order from the object for the face area determined to be located in the background.

In the example shown in FIG. 10, the front/back determination unit 136 compares a distance dia between both eyes and a distance dib between both eyes and determine that a face area having a longer distance dia between both eyes is located in the foreground and a face area having a shorter distance dib between both eyes is located in the background. Therefore, the image synthesis unit 137 first synthesizes an object Obj3b according to the position of the face area determined to be located in the background and thereafter synthesizes an object Obj3a according to the position of the face area determined to be located in the foreground.

If the objects are synthesized in such an order, a synthesized image Smg31, in which objects are synthesized in a correct order, is generated. Although, in the example shown in FIG. 10, the plurality of objects to be synthesized are different from each other, the objects may be the same.

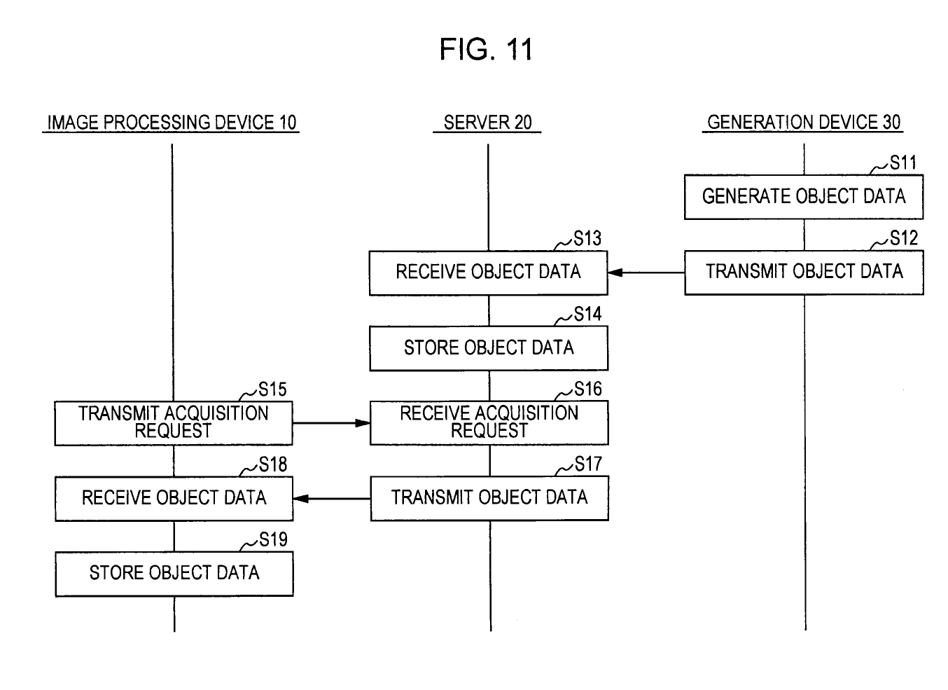

The method for reducing the probability that the order of the synthesis of the objects is mistaken when objects are synthesized at a plurality of positions on the captured image has been described. Hereinafter, an operation example of the image processing system 1 will be described with reference to FIG. 11.

FIG. 11 is a sequence diagram showing the operation example of the image processing system 1. As shown in FIG. 11, first, the generation device 30 generates object data (step S11). As described above, the object data includes an object, a central position between both eyes, and a distance between both eyes. Also as described above, for example, the generation device 30 generates object data on the basis of an operation of the object creator. Subsequently, the generation device 30 transmits the generated object data to the server 20 via the network 40. The object data is transmitted on the basis of an operation of the object creator.

Subsequently, the server 20 receives the object data transmitted from the generation device 30 via the network 40 (step S13) and stores the received object data (step S14). The image processing device 10 transmits an acquisition request to the server 20 via the network 40 by the communication device 915 to acquire object data (step S15). The timing of transmitting the acquisition request is not particularly limited. For example, the acquisition request may be transmitted when a transition operation to the object selection menu is performed or when an operation to acquire an object is performed.

When the server 20 receives the acquisition request transmitted from the image processing device 10 via the network 40 (step S16), the server 20 transmits stored object data to the image processing device 10 via the network 40 (step S17). The object data transmitted here may be objet data specified by the acquisition request or object data that can be transmitted to the image processing device 10 regardless of whether being specified or not by the acquisition request.

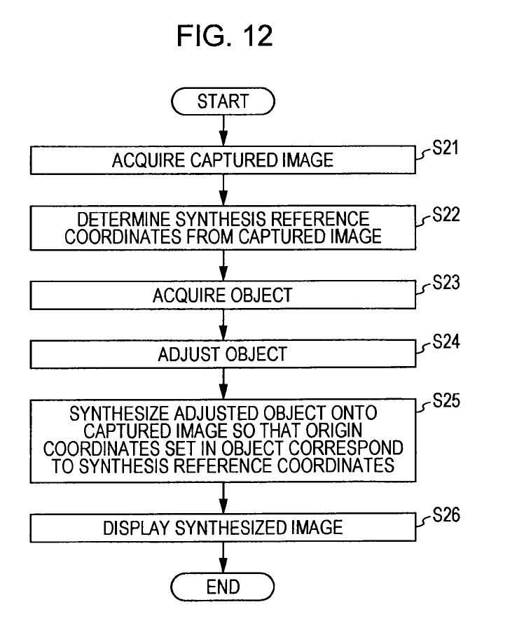

When the image processing device 10 receives the object data transmitted from the server 20 via the network 40 by the communication device 915 (step S18), the image processing device 10 stores the object data received by the communication device 915 (step S19). The object data received by the communication device 915 may be stored in the storage device 911 or may be stored in the removable storage medium 50. The object data stored in this way can be used in an operation as described in FIG. 12.

For example, it is also assumed that the storage device 911 and the removable storage medium 50 have already stored object data. In this case, it is not necessary to perform the operation (step S11 to step S19) shown in FIG. 11. When the server 20 has already stored the object data, it is not necessary to perform a part of the operation (step S11 to step S14) shown in FIG. 11.

The operation example of the image processing system 1 has been described. Hereinafter, an operation example of the image processing device 10 will be described with reference to FIG. 12.

FIG. 12 is a flowchart showing the operation example of the image processing device 10. As shown in FIG. 12, first, the captured image acquisition unit 132 acquires a captured image (step S21). As described above, the captured image acquired by the captured image acquisition unit 132 may be acquired from the storage device 911 or may be acquired from other locations. The timing of receiving the captured image is not particularly limited. For example, the captured image may be received when an operation to acquire a captured image (for example, an image capturing operation) is performed by the operation detection unit 110.

Subsequently, the reference position determination unit 135 determines the synthesis reference coordinates from the captured image acquired by the captured image acquisition unit 132 (step S22). For example, as described above, the reference position determination unit 135 determines the synthesis reference coordinates based on the position of the face area included in the captured image. As described above, if synthesis reference coordinates determined by another device is added to the captured image, the synthesis reference coordinates added to the captured image may be used, so that it is not necessary to perform step S22.

Subsequently, the object acquisition unit 131 acquires an object (step S23). As described above, the object acquired by the object acquisition unit 131 may be acquired from the storage device 911 or may be acquired from other locations.

Subsequently, the object adjustment unit 134 adjusts the object acquired by the object acquisition unit 131 (step S24). As described above, the adjustment method of the object by the object adjustment unit 134 is not particularly limited. The object is not necessarily adjusted. Subsequently, the image synthesis unit 137 synthesizes the adjusted object onto the captured image so that the origin coordinates set in the object correspond to the synthesis reference coordinates (step S25). When the synthesized image generated by the image synthesis unit 137 is controlled to be displayed by the display control unit 140, the synthesized image is displayed by the output device 910 (step S26).

The synthesized image generated by the image synthesis unit 137 is not necessarily displayed by the output device 910. For example, the synthesized image generated by the image synthesis unit 137 may be stored in the storage device 911, may be stored in the removable storage medium 50, or may be transmitted to another device.

### 2. CONCLUSION

As described above, according to the embodiment of the present disclosure, it is possible to synthesize an object, in which the origin coordinates are set, onto a captured image so that the origin coordinates correspond to the synthesis reference coordinates based on the position of the face area included in the captured image. Therefore, according to the embodiment of the present disclosure, it is possible to synthesize an object at an appropriate position on a captured image.

Although the embodiment of the present disclosure has been described in detail with reference to the drawings, the technical scope of the present disclosure is not limited to the embodiment. It is obvious that a person with an ordinary skill in the art to which the present disclosure pertains can make various changes or modifications of the embodiments within the technical idea described in the claims of the present disclosure, and of course, it is understood that these changes or modifications are within the technical scope of the present disclosure.

For example, although, in the above embodiment, examples in which the synthesis processing unit 130 is included in the image processing device 10 are mainly described, a functional unit corresponding to the synthesis processing unit 130 may be included in the server instead of the image processing device 10. For example, when the image processing device 10 transmits the object data and the captured image to the server, the server, instead of the image processing device 10, may provide a service for synthesizing the object onto the captured image and transmitting the synthesized image to the image processing device 10. Such a service may be implemented by, for example, a web service.

The steps in the operation of the image processing device 10 in the description are not necessarily performed in a chronological order along the sequences described as the flowchart and the sequence diagram. For example, the steps in the operation of the image processing device 10 may be performed in a sequence different from the sequences described as the flowchart and the sequence diagram or may be performed in parallel.

It is possible to create a computer program for causing the hardware such as the CPU, the ROM, and the RAM included in the image processing device 10 to perform the same functions as those of the constituent elements of the image processing device 10 described above. A storage medium in which the computer program is stored is provided.

The configurations described below are also included in the technical scope of the present disclosure.

(1) An apparatus including:

an object adjustment unit configured to modify an image of an object based on parameters of an image of a face to create a modified image of the object; and

a synthesis unit configured to synthesize the image of the face with the modified image of the object.

(2) The apparatus according to (1), wherein the object adjustment unit modifies the image of the object by scaling a size of the object based on the parameters of the image of the face.
(3) The apparatus according to (1) or (2), further comprising:

an input unit configured to receive a selection of the image of the face from among a plurality of faces in the image.

(4) The apparatus according to (1) to (3), further comprising:

a display configured to display the image of the face synthesized with the modified image of the object.

(5) The apparatus according to (4), wherein the display displays a plurality of images including a face that can be synthesized with the image of the object.
(6) The apparatus according to (4) or (5), wherein the display displays a plurality of images of objects that can be synthesized with the image of the face.
(7) The apparatus according to (4) to (6), further comprising:

an input unit configured to receive a command to rotate the modified image of the object with respect to the image of the face.

(8) The apparatus according to (4) to (7), further comprising:

an input unit configured to receive a command to drag the modified image of the object in a linear direction with respect to the image of the face.

(9) The apparatus according to (8), wherein the synthesis unit drags the modified image of the object in a horizontal direction with respect to the image of the face when a difference between a drag direction of the command and the horizontal direction is less than a threshold.
(10) The apparatus according to (8), wherein the synthesis unit drags the modified image of the object in a vertical direction with respect to the image of the face when a difference between a drag direction of the command in a vertical direction is less than a threshold.
(11) The apparatus according to (9) or (10), wherein the synthesis unit drags the modified image of the object in the drag direction with respect to the image of the face when the difference between the drag direction of the command and the horizontal direction exceeds the threshold and the difference between the drag direction of the command and the vertical direction exceeds the threshold.
(12) The apparatus according to (4) to (11), further comprising:

an input unit configured to receive a command to scale the modified image of the object with respect to the image of the face.

(13) The apparatus according to (12), wherein the synthesis unit scales the modified image of the object in a horizontal direction with respect to the image of the face when a difference between a drag direction of the command and the horizontal direction is less than a threshold.
(14) The apparatus according to (12), wherein the synthesis unit scales the modified image of the object in a vertical direction with respect to the image of the face when a difference between a drag direction of the command in a vertical direction is less than a threshold.
(15) The apparatus according to (13) or (14), wherein the synthesis unit scales the modified image of the object in the drag direction with respect to the image of the face when the difference between the drag direction of the command and the horizontal direction exceeds the threshold and the difference between the drag direction of the command and the vertical direction exceeds the threshold.
(16) The apparatus according to (1) to (15), further comprising:

a front/back relationship determination unit configured to determine a front/back relationship between each of a plurality of face areas in the image.

(17) The apparatus according to (16), wherein the synthesis unit synthesizes modified images of objects with images of faces in an order determined by the front/back relationship determination unit.
(18) The apparatus according to (16) or (17), wherein the synthesis unit synthesizes modified images of objects with images of faces in an order determined by the front/back relationship determination unit such that a rearmost image of a face is synthesized with a corresponding modified image of an object first and a frontmost image of a face is synthesized with a corresponding modified image of an object last.
(19) A method including:

modifying an image of an object based on parameters of an image of a face to create a modified image of the object; and

synthesizing the image of the face with the modified image of the object.

(20) A non-transitory computer readable medium encoded with a program that, when loaded on a processor, causes the processor to perform a method including:

modifying an image of an object based on parameters of an image of a face to create a modified image of the object; and

synthesizing the image of the face with the modified image of the object.

What is claimed is:

1. An apparatus comprising:
an object adjustment unit configured to modify an image of an object based on parameters of an image of a face to create a modified image of the object; and
a synthesis unit configured to synthesize the image of the face with the modified image of the object.

2. The apparatus according to claim 1, wherein the object adjustment unit modifies the image of the object by scaling a size of the object based on the parameters of the image of the face.

3. The apparatus according to claim 1, further comprising:
an input unit configured to receive a selection of the image of the face from among a plurality of faces in the image.

4. The apparatus according to claim 1, further comprising:
a display configured to display the image of the face synthesized with the modified image of the object.

5. The apparatus according to claim 4, wherein the display displays a plurality of images including a face that can be synthesized with the image of the object.

6. The apparatus according to claim 4, wherein the display displays a plurality of images of objects that can be synthesized with the image of the face.

7. The apparatus according to claim 4, further comprising:
an input unit configured to receive a command to rotate the modified image of the object with respect to the image of the face.

8. The apparatus according to claim 4, further comprising:
an input unit configured to receive a command to drag the modified image of the object in a linear direction with respect to the image of the face.

9. The apparatus according to claim 8, wherein the synthesis unit drags the modified image of the object in a horizontal direction with respect to the image of the face when a difference between a drag direction of the command and the horizontal direction is less than a threshold.

10. The apparatus according to claim 8, wherein the synthesis unit drags the modified image of the object in a vertical direction with respect to the image of the face when a difference between a drag direction of the command in a vertical direction is less than a threshold.

11. The apparatus according to claim 9, wherein the synthesis unit drags the modified image of the object in the drag direction with respect to the image of the face when the difference between the drag direction of the command and the horizontal direction exceeds the threshold and the difference between the drag direction of the command and the vertical direction exceeds the threshold.

12. The apparatus according to claim 4, further comprising:
an input unit configured to receive a command to scale the modified image of the object with respect to the image of the face.

13. The apparatus according to claim 12, wherein the synthesis unit scales the modified image of the object in a horizontal direction with respect to the image of the face when a difference between a drag direction of the command and the horizontal direction is less than a threshold.

14. The apparatus according to claim 12, wherein the synthesis unit scales the modified image of the object in a vertical direction with respect to the image of the face when a difference between a drag direction of the command in a vertical direction is less than a threshold.

15. The apparatus according to claim 13, wherein the synthesis unit scales the modified image of the object in the drag direction with respect to the image of the face when the difference between the drag direction of the command and the horizontal direction exceeds the threshold and the difference between the drag direction of the command and the vertical direction exceeds the threshold.

16. The apparatus according to claim 4, further comprising:
a front/back relationship determination unit configured to determine a front/back relationship between each of a plurality of face areas in the image.

17. The apparatus according to claim 16, wherein the synthesis unit synthesizes modified images of objects with images of faces in an order determined by the front/back relationship determination unit.

18. The apparatus according to claim 16, wherein the synthesis unit synthesizes modified images of objects with images of faces in an order determined by the front/back relationship determination unit such that a rearmost image of a face is synthesized with a corresponding modified image of an object first and a frontmost image of a face is synthesized with a corresponding modified image of an object last.

19. A method comprising:
modifying an image of an object based on parameters of an image of a face to create a modified image of the object; and
synthesizing the image of the face with the modified image of the object.

20. A non-transitory computer readable medium encoded with a program that, when loaded on a processor, causes the processor to perform a method comprising:
modifying an image of an object based on parameters of an image of a face to create a modified image of the object; and
synthesizing the image of the face with the modified image of the object.
